(19) United States
(12) Patent Application Publication
(10) Pub. No.: US 2007/0008719 A1
(43) Pub. Date: Jan. 11, 2007

(54) Hand-held retractable flashlight

(76) Inventor: James Wilson Hill, Myrtle Beach, SC (US)

Correspondence Address: William Propp, Esq., 8205 Santa Monica Blvd., PMB1-245, West Hollywood, CA, 90046, US

(21) Appl. No.: 11/178,933

(22) Filed: Jul. 11, 2005

(51) Int. Cl. F21L 4/04

(52) U.S. Cl. 362/198; 362/191; 362/387; 362/490

(57) ABSTRACT

A hand-held flashlight with gripping means is connected by a retractable tether to a spool housing. The flashlight is a self-contained unit with a light emitting diode (LED) light source, batteries and a contact switch. One end of the tether is connected to the base of the flashlight. The other end of the tether is wound round the spool in the housing. A coil spring is mounted between the housing and spool to bias the tether in a retracted position around the spool. The contact switch automatically turns on the flashlight when the flashlight is extended away from the housing and turns off the flashlight when the flashlight is retracted back to the housing. The contact switch can be a magnetic reed switch or a pushbutton switch. The gripping means allow the flashlight to be held securely by hand in any weather condition or environment.

### BACKGROUND OF THE INVENTION

This invention relates generally to a flashlight and, more particularly, this invention is directed to a hand-held flashlight with gripping means connected by a retractable tether to a spool housing.

Flashlights are often used in dark work environments or in work environments under difficult weather conditions such as rain, snow and sleet.

Flashlights are difficult to find in semi or complete darkness or under heavy weather conditions when the flashlight is not in use. If the flashlight is left on an object, the user has to either leave the flashlight on, draining the battery; or in the midst of a dark work environment or under difficult weather conditions; the user has to remember exactly where the user left the flashlight.

Furthermore, a flashlight is typically cylindrical in shape. A cylindrical-shaped flashlight tends to roll when placed on an uneven surface or when subjected to wind and rain. Heavy rain or heavy snow may indeed cover the flashlight from the user's sight.

The flashlight can be placed somewhere in the user's clothes or work equipment but that location may not provide easy access or easy to remember access for a user in a work environment in semi or complete darkness or under difficult weather conditions.

The on/off switch on a flashlight either requires one hand or two hands to operate. A slide switch or a push button switch on the flashlight requires one hand to use. A twist switch on a flashlight requires two hands with one hand to hold the flashlight while the other hand twists a portion of the flashlight.

It would be useful to have an on/off switch for a flashlight that requires no hands to operate when the user is in dark work environments or in work environments under difficult weather conditions.

Spool housings are typically used for tape measures and dog leashes. A tape measure or a leash is wound round a spool in a housing. The tape measure or leash can be pulled out of the housing and then will rewind back into the housing.

Tape measures typically do not have any lighting attached. In a few inventions, a light will be attached to the tape measure housing so the measurements on the tape at the housing can be read in dim light.

U.S. Pat. No. 5,544,420 is a tape measure with a light bulb at the end of the measuring tape to illuminate the immediate area at the end of the tape. Batteries for the light bulb are in the tape measure housing. Electrically conductive wires run along the bottom of the measuring tape from the batteries in the housing to the light bulb at the end of the measuring tape. The measuring tape lock is used as a switch to complete the electrical circuit and turn the light bulb on.

A dog leash on a spool housing also typically does not have any lighting attached. In a few inventions, a light will be attached to the dog leash housing so the dog owner can see the immediate area where the dog and the owner are.

U.S. Pat. No. 6,003,472 is a dog leash spool housing with a flashing beacon unit light at the far end of the leash, attached to the dog. The flashing beacon indicates the position of the dog rather than illuminating the area surrounding the dog. The dog leash flashing beacon does not have any on/off switch and is constantly on.

It is an object of this invention to provide a flashlight with a hands-free on/off switch.

It is a further object of this invention to provide a flashlight that is easy to access and conveniently located for the user.

### SUMMARY OF THE INVENTION

According to the present invention, a hand-held flashlight with gripping means is connected by a retractable tether to a spool housing. The flashlight is a self-contained unit with a light emitting diode (LED) light source at the front end, a battery power source and an on/off contact switch at the base. The flashlight housing is typically manufactured of a rugged, rigid, temperature-insensitive and moisture-insensitive material such as cast metal or molded plastic.

The gripping means allow the flashlight to be held securely by hand in any weather condition or environment. The gripping means extend over a portion of the outside of the flashlight housing.

The gripping means can be formed of the same material as the flashlight housing and be a series of concentric ridges extending from the flashlight housing. Conversely, the gripping means can be a series of indentations or grooves in the flashlight housing. The gripping means can alternately be a plastic, polymer or rubber, which is adhesively or chemically bonded to the flashlight housing.

One end of the tether is connected to the base of the flashlight. The other end of the tether is wound round the spool in the spool housing. The spool has a first large annular flange, a smaller cylindrical barrel and a second large annular flange which form a u-shaped traverse for storing the tether as the tether retracts and extends out of the spool housing. A cylindrical shaft extends from the barrel to the inside major walls of the spool housing to form an axle upon which the spool rotates in position.

A coil spring is mounted in the annular space between the second flange of the spool and the second major wall of the spool housing. The coil spring will continuously bias the tether into a retracted position into the spool housing and around the spool. The coil spring is typically fabricated from a highly resilient material, such as spring steel.

The spool housing will have an aperture on the second inside wall of the spool housing. A ring or hook is positioned on an edge of the spool housing. The tether will play out of the spool through the ring through the aperture out of the spool housing and will retract back into the spool housing through the aperture through the ring and around the spool through the aperture.

Alternately, the spool housing will have an aperture in line with the traverse of the spool. The tether will play out of the spool and out the spool housing through the aperture and will retract back into the spool housing and around the spool through the aperture.

A bracket can be used in the spool housing to hold the spool against one major wall of the spool housing.

The spool housing is typically manufactured of a rugged, rigid, temperature-insensitive and moisture-insensitive material such as cast metal or molded plastic.

The contact switch for the flashlight can be a pushbutton switch or a magnetic reed switch. For a magnetic reed switch, a magnet is positioned near the aperture of the spool housing. The magnetic reed switch at the base of the flashlight automatically turns on the flashlight when the flashlight is extended away from the magnet on the spool housing and turns off the flashlight when the flashlight is retracted back to the magnet on the spool housing.

A recess in the spool housing centered around the aperture can hold the flashlight housing when the flashlight is retracted back to the spool housing. The recess is the same shape as the base of the flashlight housing and slightly larger. The recess provides full contact between the magnetic reed switch in the flashlight housing and the magnet in the spool housing.

The spool housing can be mounted or manufactured integral with the front roof section of an automobile so that the hand-held flashlight with gripping means is a retractable map light.

The spool housing has a clip on an outside surface so the spool housing can be securely but removably attached to the belt or clothes of the user. The user has easy access to grasp and hold the flashlight. The spool housing could alternately have a strap on an outside surface so the spool housing can be securely but removably attached to the wrist or body of the user.

The exterior of the flashlight housing may have a clip or strap to secure the flashlight to an object. The tether from the flashlight housing to the spool housing still connects the user to the flashlight.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a perspective view of the flashlight, tether and spool housing of the first embodiment of the hand-held retractable flashlight system of the present invention

FIG. 2 is a cross-sectional side view of the flashlight of the hand-held retractable flashlight system of FIG. 1.

FIG. 3 is a cross-sectional side view of the spool housing of the hand-held retractable flashlight system of FIG. 1.

FIG. 4 is a cross-sectional top view of the spool housing of the hand-held retractable flashlight system of FIG. 1.

FIG. 5 is a cross-sectional side view of the spool housing with the spool held in place by a bracket of the second embodiment of the hand-held retractable flashlight system of the present invention.

FIG. 6 is a cross-sectional side view of the spool housing with the power source on the spool, an electrically conductive tether and the flashlight without a power source of the third embodiment of the hand-held retractable flashlight system of the present invention.

FIG. 7 is a side view of a flashlight and a recessed spool housing of the fourth embodiment of the hand-held retractable flashlight system of the present invention.

FIG. 8 is a cross-sectional side view of the spool housing with the tether aperture in a side wall of the fifth embodiment of the hand-held retractable flashlight system of the present invention.

FIG. 9 is a side view of the hand-held retractable flashlight system in an automobile according to the present invention.

FIG. 10 is a side view of a clip attaching the spool housing of the hand-held retractable flashlight system of the present invention to a user's belt.

FIG. 11 is a side view of a strap attaching the spool housing of the hand-held retractable flashlight system of the present invention to a user's wrist.

FIG. 12 is a side view of a clip attaching the flashlight of the hand-held retractable flashlight system of the present invention to an object.

### DETAILED DESCRIPTION OF PREFERRED EMBODIMENTS

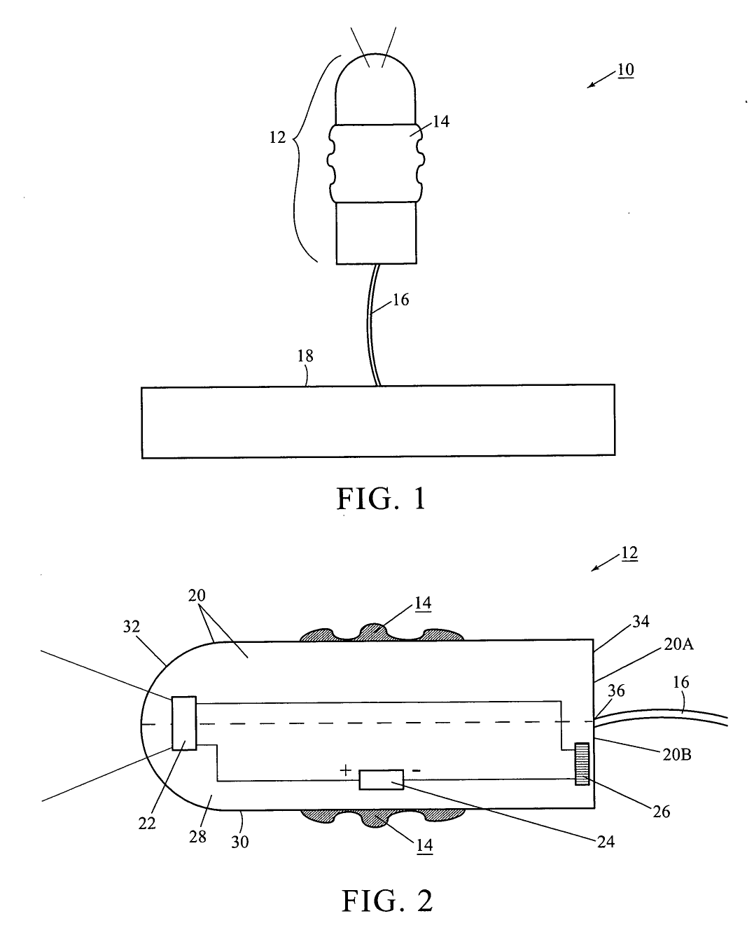

Reference is now made to FIG. 1 illustrating the hand-held retractable flashlight system 10 of the present invention.

The hand-held retractable flashlight system 10 has a flashlight 12 with griping means 14 connected by a tether 16 to a spool housing 18.

The flashlight 12, as shown in FIG. 2, has a flashlight housing 20 with a light source 22, a power source 24, and an on/off contact switch 26 within the interior 28 of the housing and the gripping means 14 on the exterior 30 of the housing.

The flashlight 12 has a first end 32 or light emission area and a second end 34 or base. The light emission area 32 is on the opposite side of the flashlight 12 from the base 34.

The light source 22 is a light emitting diode (LED), which emits light from the flashlight 12 at the first end 32. The light source can alternately be an array of light emitting diodes or an incandescent bulb, depending upon the power needs of the light source and the desired output brightness of the light beam emitted by the light source. Again alternately, the light source can be a laser, a fluorescent light or an electroluminescent light source.

The light source can emit white light, light of any color, or light of a combination of colors, or infrared or ultraviolet light. The light emission area 32 will be transparent to the wavelength of the emitted light from the light source. The light emission area will typically be plastic or glass. The light emission area can be a lens to focus the emitted light to provide a more intense, brighter light.

The flashlight 12 has the light source 22 at the first end 32, the power source 24 and any other circuitry in the middle and the on/off contact switch 26 at the base 34 of the flashlight.

The power source 24 for the light source 22 is typically a battery or a series of batteries. The battery or batteries can be a button battery or a penlight battery, depending upon the size of the flashlight housing, the power needs of the light source and the desired output brightness of the light beam emitted by the light source.

The power source 24 can be located at the first end 32 of the flashlight housing 20 near the light source 22 or at the second end 34 of the flashlight housing 20 or between the first and second ends of the flashlight housing.

The on/off contact switch 26 is positioned at the second end 34 or base of the flashlight housing 20. The on/off contact switch can be a magnetic reed switch or a pushbutton switch.

The light source, power source and on/off contact switch form an electrical circuit for the flashlight within the flashlight housing. When the on/off contact switch is closed to on, electrical current will flow from the battery power source to the LED light source, which will emit a light beam. When the on/off contact switch is open to off, there is no electrical circuit from the battery power source to the LED light source and the flashlight will not emit a light beam.

The flashlight housing 20 is typically manufactured of a rugged, rigid, temperature-insensitive and moisture-insensitive material.

Examples of flashlight housing material would be plastic, polymer, rubber, metal or ceramic. The housing can be formed by molding, casting, stamping, etching, milling or other commercial manufacturing processes.

In this embodiment, the flashlight housing 20 is formed of cast metal or molded plastic. The housing has two halves 20A and 20B, which are held together by a plurality of screws (not shown in the Figure). Alternately the two halves of the flashlight housing can be chemically bonded, heat bonded or adhesively bonded together or held together by bolts and nuts. The two halves may be identical mirror image halves but they need not be for the purposes of this invention.

The flashlight housing 20 is of a size and shape to fit comfortably into the hand of a user. Typically, the flashlight housing 20 has a cylindrical shape or a long elliptical shape. The front end 32 of the flashlight housing, where light is emitted by the light source, can be rounded or flat. The base 34 of the flashlight housing 20 will typically be flat.

The gripping means 14 provides a secure hold on the flashlight 12 by the user when the retractable flashlight is being extended from the spool housing and held in place during use.

The gripping means 14 allows the retractable flashlight to be held securely in the user's hand in rain, snow, heat and cold, in any weather condition or environment.

The gripping means 14 allows the retractable flashlight to be held in the user's bare hand, or in the user's gloved hand, whether the glove is work gloves, rubber gloves or fur or fleece gloves.

The gripping means 14 extend over a portion of the outside 30 of the flashlight housing 20. The gripping means cannot cover the emission area 32 for the light source at one end of the flashlight, nor can it cover the contact switch and the tether attachment at the other end 34 of the flashlight. The gripping means can extend over all or some of the remainder of the flashlight housing.

The gripping means can be formed of the same material as the flashlight housing and be an extension of the flashlight housing. The gripping means can be a series of concentric ridges extending from the flashlight housing. The gripping means can be one or more spiral ridges.

The gripping means can also be cross-hatched ridges, dimples, web, or any other geometric or non-geometric pattern of ridges. The gripping means can be lines or other patterns extending along the length of the flashlight housing.

Conversely, the gripping means can be an indentation or groove in the flashlight housing in a series of concentric circles, cross-hatched, dimples, web, or any other geometric or non-geometric pattern of grooves or indentations. The gripping means can be one or more spiral indentations or grooves. The gripping means can be grooves or other indentation patterns extending along the length of the flashlight housing.

The gripping means can be formed of a different material from the flashlight housing. Examples of gripping means material would be plastic, polymer, rubber, metal, ceramic, thermoplastic elastomer, nylon or cotton. The gripping means on the flashlight housing can be a series of concentric circles, cross-hatched, dimples, web, or any other geometric or non-geometric pattern of one or more ridges, grooves or indentations. The gripping means can be secured to the flashlight housing by adhesive, by bonding or by tightly wrapping.

The tether 16 can be a wire or a woven cord made from plastic, polymer, leather, nylon, silk, cotton, rubber, thermoplastic elastomer, wool or string. The tether should have sufficient length, flexibility and strength to extend and retract from the spool housing for long period of time under difficult weather and working conditions.

Ideally, the tether should be fabricated to reduce tangling with itself and outside elements.

A first end 36 of the tether 16 is attached to the second end 34 or base of the flashlight housing 20. The first end of the tether can be secured by an adhesive or bonding to the flashlight housing base. Alternately, the first end of the tether may be inserted into a hole in the base of the flashlight housing and knotted on the inside of the flashlight housing to attach the tether to the housing.

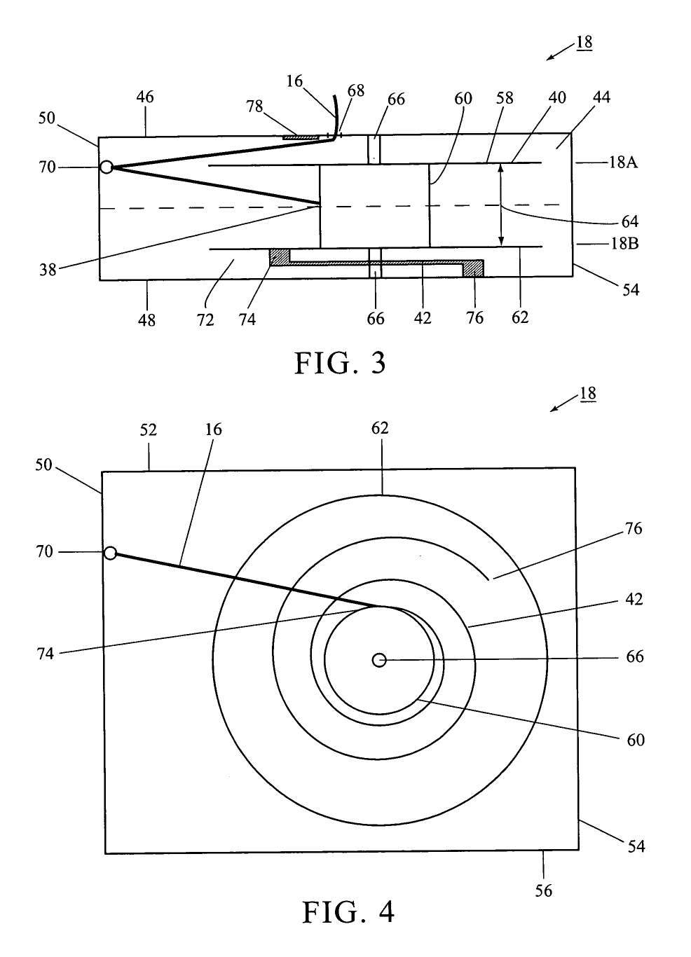

As shown in FIG. 3 and FIG. 4, the first embodiment of the spool housing 18 has the second end 38 of tether 16 secured to a spool 40. A biasing means 42, such as a spring, retracts the tether 16 into the housing 18 and around the spool 40.

The spool housing 18 is typically manufactured of a rugged, rigid, temperature-insensitive and moisture-insensitive material. Examples of suitable spool housing material would be plastic, polymer, rubber, metal or ceramic. The housing can be fabricated by molding, casting, stamping, etching, milling or other commercial manufacturing processes. The spool housing and the flashlight housing may be fabricated from the same material by the same manufacturing technique. Alternately, the spool housing and the flashlight housing may be fabricated from different materials and/or by different manufacturing processes.

In this embodiment, the spool housing 18 is formed of cast metal or molded plastic. The housing has two identical mirror-image halves 18A and 18B, which are held together by adhesive bonding. Alternately the two halves of the spool housing can be chemically bonded, heat bonded or held together by screws or bolts and nuts. The two halves are mirror image halves but they need not be for the purposes of this invention. The housing may be fabricated from non-identical sections.

The spool housing 18 forms an interior cavity 44 for the spool 40; the biasing means 42 for the spool and the tether 16. The cavity is generally cylindrical in shape since the enclosed spool is cylindrical.

The spool housing 18 is rectangular in this example. The spool housing 18 has two major opposing walls 46 and 48 and four side walls 50, 52, 54, and 56. The first or top major wall 46 is opposite the second or bottom major wall 48. The first and second major walls 46 and 48 are parallel to each other and spaced apart.

The four side walls 50, 52, 54, and 56 connect the first and second major walls 46 and 48 to form the spool housing 18.

The first side wall 50 is opposite the third side wall 54. The second side wall 52 is opposite the fourth side wall 56. The first and third side walls 50 and 54 are perpendicular to the second and fourth side walls 52 and 56.

The first and second major walls are generally rectangular or square in shape, with approximately equal sides. The two major walls 46 and 48 are generally larger than the four side walls 50, 52, 54, and 56. The side walls will generally be rectangular in shape with two long sides and two short sides.

The cylindrical spool 40 has a first annular planar flange 58 connected by a cylindrical barrel 60 to a second annular planar flange 62. The first and second planar flanges 58 and 62 are parallel and spaced apart from each other. The barrel 60 is perpendicular to the first and second flanges 58 and 62. The barrel's outer diameter is the inner diameter of the first and second annular flanges. The first and second annular flanges'outer diameter is greater than their inner diameter and greater than the outer diameter of the barrel. The first annular flange 58, the barrel 60 and the second annular flange 62 forms a u-shaped traverse 64 for storing the tether 16 as the tether retracts and extends out of the spool housing 18.

The first and second major walls 46 and 48 of the spool housing are spaced apart from the cylindrical spool 40 in the cavity of the spool housing. The first major wall 46 is adjacent to the first annular flange 58 of the spool. The second major wall 48 is adjacent to the second annular flange 62 of the spool.

A cylindrical shaft 66 extends outward from the barrel 60 past the first flange 58 to the first major wall 54 of the spool housing 18. On the other side of the spool 40, the cylindrical shaft 66 extends outward from the barrel 60 past the second flange 62 to the second major wall 56 of the spool housing 18. The shaft 66 is parallel to the barrel 60 and perpendicular to the first and second annular flanges 58 and 62. The shaft 66 is rigidly attached to the spool 40. The shaft 66 is perpendicular to the first and second inside walls 54 and 56 of the spool housing.

The shaft, and the attached spool, will freely rotate in position against the inside major walls of the spool housing. The shaft forms an axle upon which the spool rotates in position. Bearings (not shown in the Figure) can be provided between the shaft and the major walls of the spool housing to assist free rotation of the shaft and spool. A recess or raised lip (also not shown in the Figure) on the inside major walls of the spool housing will maintain the shaft in position without effecting the free rotation of the shaft and attached spool.

The flanges 58 and 62, barrel 60 and shaft 66 of the spool 40 can be fabricated from cast metal or molded plastic.

The spool housing 18 will have an aperture 68 in the first major wall 54 of the spool housing. The aperture is centered in position in the first major wall. The cylindrical shaft of the spool is positioned off-center in the first and second major wall. This off-center positioning will not effect the rotation of the spool and the operation of the embodiments of the invention.

The aperture 68 will have a smooth surface. The aperture may have an outward flare and/or an inward flare on the spool housing (not shown in the Figure). The smooth or flared surface will prevent damage to the tether.

The spool housing 18 will have a closed ring 70 on the first side wall 50 of the spool housing. The tether 16 is threaded through the ring 70.

The ring 70 will have a smooth, non-abrasive surface to prevent damage to the tether and permit free movement of the tether through the ring. Reduced friction coatings or reduced friction material, as are known in the art, can be used on the surface of the ring.

The tether 16 will run from the flashlight housing outside the spool housing through the aperture 68 in the spool housing into the interior cavity 44 of the spool housing. The tether will run from the aperture 68 through the ring 70 to wind around the barrel 60 between the first and second flanges 58 and 62 in the traverse 64.

When the flashlight housing is extended away from the spool housing by the user, the tether will unwind from the barrel between the first and second flanges in the traverse of the spool. The tether will play out through the ring and then through the aperture to the flashlight housing.

When the flashlight housing is retracted back to the spool housing, the tether will pull in through the aperture and then through the ring. The tether will then wind up around the barrel between the first and second flanges in the traverse of the spool.

The aperture 68, ring 70 and first flange 58 of the spool 40 are positioned relative to each other so that the tether 16 does not touch the first flange while the tether is being extended or retracted from the spool out through the aperture. The ring redirects the tether between the aperture in the first major wall of the spool housing and the transverse of the spool.

The ring can be closed, as in this example, or alternately, an open hook or open flange. The ring can be a rigid structure, as in this example, or alternately a flexible structure.

Examples of suitable ring material would be plastic, polymer, rubber, metal or ceramic. The ring can be fabricated by molding, casting, stamping, etching, milling or other commercial manufacturing processes. The ring, the spool housing and the flashlight housing may be fabricated from the same material by the same manufacturing technique. Alternately, the ring, the spool housing and the flashlight housing may be fabricated from different materials and/or by different manufacturing processes.

In this embodiment, the ring 70 is formed of molded plastic. The ring can be bonded to the first side wall by adhesive bonding, chemical bonding, heat bonding, or held together by screws or bolts and nuts.

The second end 38 of the tether is attached to the barrel 60 of the spool or to the inner diameter of the first or second annular flanges 58 and 62. The second end of the tether can be secured by an adhesive or bonding. Alternately, the second end of the tether may be inserted into a hole in the barrel or flange of the spool and knotted on the inside of the barrel or flange to attach the tether to the spool.

The biasing means 42 in the spool housing 18 for the spool 40 is a coil spring. The coil spring is mounted in the annular space 72 between the second flange 62 of the spool and the second major wall 56 of the spool housing. The coil spring will continuously bias the tether into a retracted position into the spool housing and around the spool. The coil spring is typically fabricated from a highly resilient material, such as spring steel.

The inner end 74 of the coil spring 42 is attached to the second flange 62 of the spool 40 near the shaft 66 while the outer end 76 of the coil spring is attached to the second major wall 56 of the spool housing 18. The spring can be attached by inserting the end of the spring into a slot in the spool flange and a slot in the major wall of the spool housing. Alternately, the coil spring end can be chemically bonded, heat bonded or adhesively bonded to the spool or spool housing.

The coil spring 42 extends radially outward from the shaft 66 next to the spool in a spiral. When the coil spring is wound into a spiral and connected to both the spool and spool housing, the spring produces a biasing force on the spool opposing the rotation of the spool about the shaft as the tether is extended out of the spool housing since this action causes the spring to coil more tightly about itself. This biasing force retracts the tether 16 back into the spool housing 18 and around the spool 40 as the spring uncoils.

As shown in the Figures, only a single spring is used as the biasing means for the spool. Alternately, a pair of springs, one on each side of the spool, may be used as the biasing means when a greater biasing force for the spool is needed.

The spring is preferably manufactured from steel and fabricated by known techniques. Alternately, other metals or polymers may be used as materials for the spring.

The biasing means for the spool in the spool housing is preferably a spring. Alternately, the biasing means may be a hand crank or a motor.

The on/off contact switch is a magnetic reed switch in this embodiment. A magnet 78 is positioned near the aperture 68 on the first major wall 54 inside of the spool housing 18.

When the flashlight housing is retracted to the spool housing, the base of the flashlight housing is adjacent to the magnet of the spool housing. The magnetic field of the spool housing magnet will close the magnetic reed switch on the wall of the flashlight housing. The closed reed switch will open the electrical circuit for the light source and the power source of the flashlight and the light source will not emit light.

When the flashlight is extended away from the spool housing, the base of the flashlight is away from the magnet of the spool housing. The magnetic field of the spool housing magnet is too weak or non-existent to effect the magnetic reed switch on the base of the flashlight housing. The reed switch will be open. The open reed switch will close the electrical circuit for the light source and the power source of the flashlight and the light source will emit light.

Alternately, the magnet for the magnetic reed switch can be positioned on the outside of the spool housing.

Instead of a magnetic reed switch, the on/off contact switch can be a physical contact switch, such as a pushbutton switch. The pushbutton switch has a raiser actuator, such as a plunger, that is pushed down to open or close the switch. The pushbutton contact switch can be a single pole single throw (SPST) switch. A SPST switch is a switch that makes or breaks the connection of a single conductor in a single branch circuit. In the present invention, the single circuit would be the electrical circuit in the flashlight.

In the hand-held retractable flashlight system 10 of the present invention, the actuator on the pushbutton switch would be retracted when the flashlight housing is positioned against the spool housing. The pushbutton switch would be pressed against the outside of the spool housing. With the actuator retracted, the pushbutton switch would be off, the electrical circuit for the flashlight would be open and the flashlight would not emit light.

As the flashlight and flashlight housing is pulled away from spool housing, the pushbutton switch would extend out since it is no longer pressed against the spool housing. With the actuator extended, the pushbutton switch would be on, the electrical circuit for the flashlight would be closed and the flashlight would emit light.

In operation, the hand-held retractable flashlight system 10 of the present invention has one end of the tether connected to the base of the flashlight. The second end of the tether is wound round the spool in the spool housing. The length of the tether is rotatably mounted around the spool inside the spool housing. A coil spring is mounted between the spool and the spool housing to bias the length of tether in a retracted position around the spool.

In the retracted position, the flashlight is retained against the outside of the spool housing. The magnetic reed switch at the base of the flashlight is positioned adjacent to a magnet on the spool housing. The magnet causes the switch to be in the closed (or off) position, the power circuit within the flashlight is open and the flashlight is not emitting light.

The user grasps the gripping means and pulls the flashlight away from the housing. The magnetic reed switch is released from the magnet on the housing and the switch opens, completing the power circuit within the flashlight, and the light source emits light from the flashlight.

As the flashlight is pulled away from the housing, the attached tether unwinds from the spool within the housing against the bias of the spring. The ring directs the tether from the spool to the aperture.

As the flashlight is released from the user's hand, or as the user's hand retains the flashlight but slackens the pull on the tether, the spring retracts the tether and attached flashlight back to the spool housing. The tether rewinds through the aperture around the spool inside the spool housing. The ring directs the tether from the aperture to the spool. The flashlight is retained against the spool housing, the magnetic reed switch is positioned adjacent to the magnet on the housing and is closed, the power circuit within the flashlight is open and the flashlight is turned off.

The tether is attached to the base of the flashlight housing. The spool will retract the tether through the aperture. The base of the flashlight housing is larger than the spool housing aperture through which the tether is being retracted into the spool housing. The base of the flashlight housing coming into physical contact with the spool housing at the aperture forms a stop to prevent further retraction of the tether into the spool housing.

The flashlight can be pulled away from the spool housing if the pull or tension on the tether exceeds the biasing force on the spool by the biasing spring. The tension causes the spool to rotate about the shaft in one direction so that the tether unwinds off the spool out through the aperture.

The flashlight is automatically retracted to the spool housing if the pull or tension on the tether is less than the biasing force on the spool by the biasing spring. The lessening or release of the tension causes the spool to rotate in the opposite direction to rewind the tether through the aperture around the spool.

The constant bias of the spring and the spool maintains a taut tether between the flashlight and the spool housing irregardless of whether the flashlight is being pulled away by the user, held in position by the user, or being pulled back by the user.

Even with tether fully retracted, the spool and coil spring may still maintain a bias on the tether so that the flashlight housing to be pressed against the spool housing providing full contact between the magnetic reed switch in the flashlight housing and the magnet in the spool housing.

The spool housing of the embodiments of the present invention can also be square, elliptical or cylindrical in shape. With an elliptical or cylindrical spool housing, the first and second major walls are elliptical or circular in shape respectively. The side walls can be one continuous side wall or a side wall with a plurality of sections. The other elements of the embodiments of the present invention would be the same.

The biasing means for the spool of the embodiments of the present invention may be strands of a flexible material, such as a rubber band.

The flexile material strand can be attached from the second flange to either the second major wall or one or more of the side walls. As the tether is extended, the flexible material is twisted taught around the cylindrical shaft. The twisted flexible material strand will bias the spool to retract the tether.

Again alternately and similarly, two or more strands of the flexible material can be attached from the second flange to the second major wall. As the tether is extended, the strands of the flexible material are twisted taught around the cylindrical shaft. The twisted strands of the flexible material will bias the spool to retract the tether.

The spool housing 18 of the embodiments of the present invention can have the aperture positioned off-center in the first major wall 54 of the spool housing. The cylindrical shaft of the spool is center positioned in the first and second major wall. This off-center positioning of the aperture will not effect the extension or retraction of the tether.

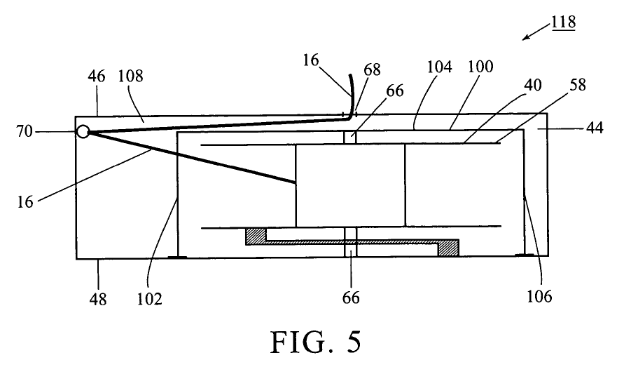

The second embodiment of the spool housing 118 as shown in FIG. 5 is the same as the first embodiment of the spool housing 18 in FIG. 3 and 4, except the spool 40 is held in place in the interior cavity 44 by a bracket 100 on one side, rather than the first major wall 46.

The bracket 100 has a first leg 102 connected by a strut 104 to a second leg 106. The first and second legs 102 and 106 are parallel and spaced apart. The strut is perpendicular to both the first and second legs. The first leg 102, strut 104 and second leg 106 form a u-shaped bracket 100.

Examples of suitable bracket material would be plastic, polymer, rubber, metal or ceramic. The bracket can be fabricated by molding, casting, stamping, etching, milling or other commercial manufacturing processes. The bracket, the ring, the spool housing and the flashlight housing may be fabricated from the same material by the same manufacturing technique. Alternately, the bracket 100, the ring 70, the spool housing 118 and the flashlight housing (not shown in this Figure) may be fabricated from different materials and/or by different manufacturing processes.

The bracket 100 is formed of cast metal or molded plastic in this embodiment.

The bracket 100 is larger than the spool 40 and smaller than the interior cavity 44 of the spool housing 118. The bracket will fit around the spool inside the interior cavity. The first and second legs 102 and 106 will be secured to the second major wall 48 of the spool housing 118.

The bracket 100 is attached by the first and second legs 102 and 106 to the second major wall 48 by a plurality of screws (not shown in the Figure). Alternately the legs of the bracket can be chemically bonded, heat bonded or adhesively bonded together or secured by bolts and nuts to the second major wall.

The cylindrical shaft 66 will extend to the strut 104 of the bracket 100 from one side of the spool 40. On the other side of the spool, the cylindrical shaft 66 will extend to the second major wall 48 of the spool housing. The shaft 66, and the attached spool 40, will freely rotate in position against the strut 104 and the inside second major wall 48 of the spool housing.

Bearings (not shown in the Figure) can be provided between the shaft and the strut of the bracket to assist free rotation of the shaft and spool. A recess or raised lip (also not shown in the Figure) on the strut of the bracket will maintain the shaft in position without effecting the free rotation of the shaft and attached spool.

An annular space 108 is provided between the bracket 100 and the first major wall 46 of the spool housing 118.

The spool housing 118 will have an aperture 68 in the first major wall 46 of the spool housing. The aperture is centered in position in the first major wall 46.

The cylindrical shaft 66 of the spool 40 is also center positioned in the spool housing 118 between the strut 102 of the bracket 100 and the second major wall 48.

The tether 16 will run from the flashlight housing outside the spool housing 118 through the aperture 68 in the spool housing 118 into the interior cavity 44 of the spool housing. The tether 16 will run from the aperture 68 through annular space 108 to the ring 70 to wind around the barrel 60 between the first and second flanges 58 and 62 in the traverse 64.

The aperture 68, ring 70 and first flange 58 of the spool 40 are positioned relative to each other in the annular space 108 and in the interior cavity 44 so that the tether 16 does not touch the first flange 58 while the tether 16 is being extended or retracted from the spool 40 out through the aperture 68.

This center positioning of both the aperture 68 and the spool 40 will not effect the rotation of the spool and the operation of the embodiments of the invention.

The bracket can have one or more legs and can be attached to the side walls in addition to the second major wall.

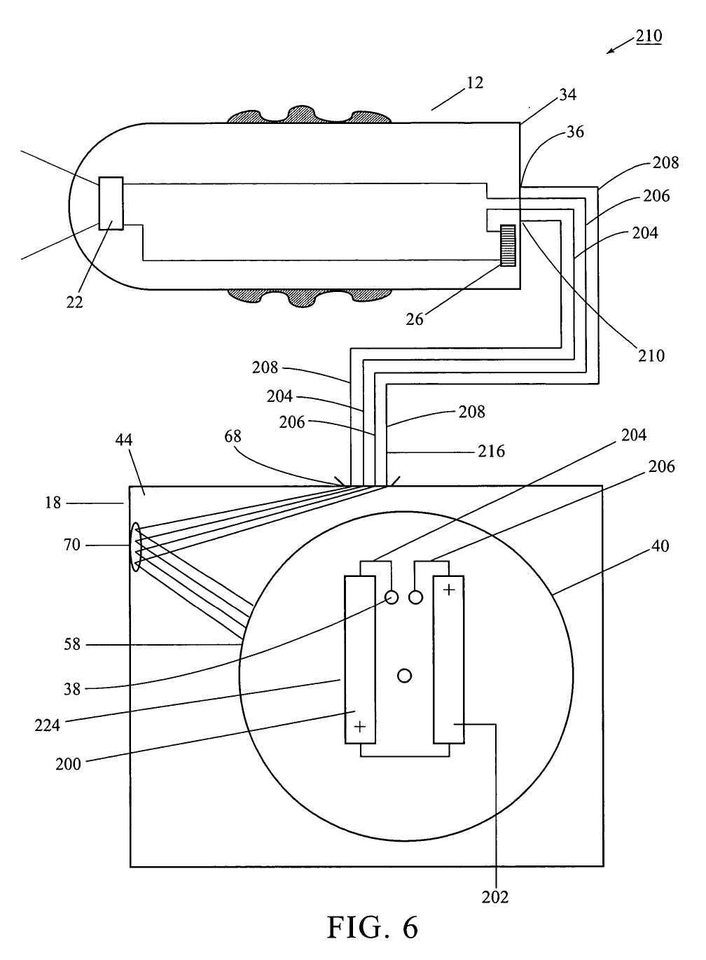

The third embodiment of the handheld flashlight 210 as shown in FIG. 6 is the same as the first embodiment of the handheld flashlight 10 in FIG. 2, 3 and 4, except that the power source 224 is on the rotatable spool 40 in the spool housing 18 and the tether 216 is electrically conductive. The light source 22 in the flashlight housing 20, the on/off switch 26 in the flashlight housing 20, the electrically conductive tether 216 and the power source 224 on the spool 40 in the spool housing 18 form an electrical circuit for the flashlight 12 within the flashlight housing 20.

The power source 224 for the light source 22 is typically a battery or a series of batteries. The battery or batteries can be a button battery or a penlight battery, depending upon the size of the flashlight housing, the power needs of the light source and the desired output brightness of the light beam emitted by the light source. In this example, the power source 224 is a first penlight battery 200 and a second penlight battery 202.

The power source 224 of the first and second batteries 200 and 202 is mounted on the outside of the first flange 58 of the spool 40, on the side away from the traverse (not shown in this Figure).

The power source 224 will rotate with the spool 40 as the tether 216 is extracted and retracted from the spool housing 18.

The power source on the first flange of the spool will not effect the rotation of the spool and the operation of the embodiments of the invention.

The aperture 68, ring 70 and first flange 58 of the spool 40 are positioned relative to each other in the interior cavity 44 so that the tether 16 does not touch the first flange 58 or the power source 224 on the first flange while the tether is being extended or retracted from the spool out through the aperture.

The power source 224 on the outside of the first flange 58 is connected to the second end of the tether 216 in the traverse of the spool at the inner diameter of the first annular flange 58. Alternately, the power source on the outside of the first flange is connected to the second end of the tether in the traverse of the spool at the barrel of the spool.

As shown in cross-section in the Figure, the tether 216 will have a first electrically conductive metal wire 204 and a second electrically conductive wire 206 core surrounded by an electrically insulative plastic cladding 208, such as a coaxial wire. The cladding could be alternately polymer or rubber. Again alternately, the entire tether can be an electrically conductive wire.

The tether 216 is electrically connected at the second end 38 of the tether to the power source 224 on the spool 40. The tether is electrically connected at the first end 36 to the flashlight 12.

The first end 36 of the tether 216 extends through a hole 210 in the base 34 of the flashlight housing 20. The first electrically conductive wire 204 is connected to the on/off switch 26 inside the flashlight housing and the second electrically conductive wire 206 is connected to the light source 22. The on/off switch 26 is also connected to the light source 22.

The light source 22 in the flashlight housing 20, the on/off switch 26 in the flashlight housing 20, the first and second electrically conductive wires 204 and 206 in the tether 216 and the power source 224 on the spool 40 in the spool housing 18 form an electrical circuit for the flashlight 12 within the flashlight housing 20.

When the flashlight housing is retracted to the spool housing, the base of the flashlight housing is adjacent to the magnet of the spool housing. The magnetic field of the spool housing magnet will close the magnetic reed switch on the wall of the flashlight housing. The closed reed switch in the flashlight will open the electrical circuit for the light source in the flashlight connected by the electrically conductive tether to the power source in the spool housing and the light source will not emit light.

When the flashlight is extended away from the spool housing, the base of the flashlight is away from the magnet of the spool housing. The magnetic field of the spool housing magnet is too weak or non-existent to effect the magnetic reed switch on the base of the flashlight housing. The reed switch will be open. The open reed switch in the flashlight will close the electrical circuit for the light source in the flashlight connected by the electrically conductive tether to the power source in the spool housing and the light source will emit light.

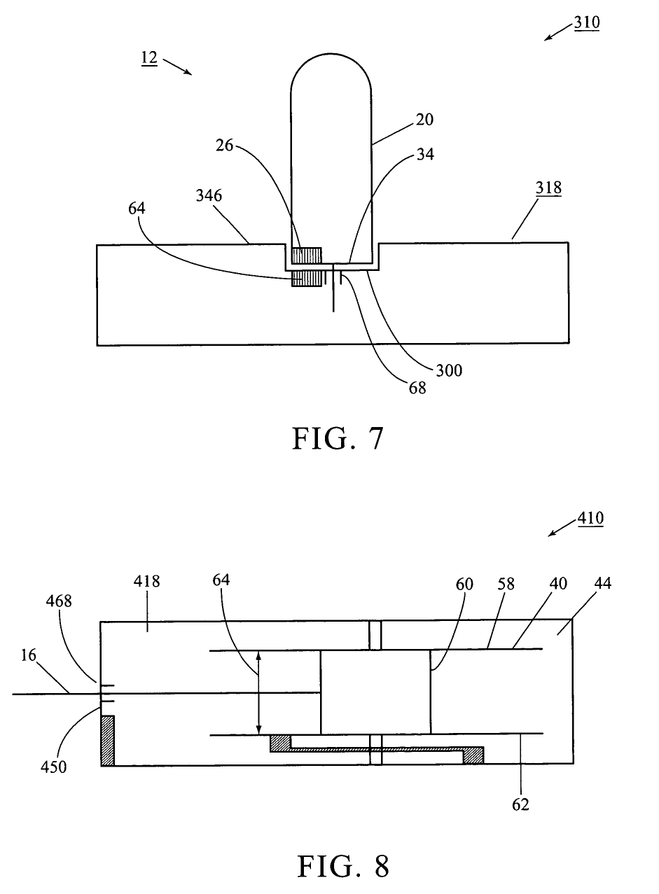

The fourth embodiment of the handheld flashlight 310 as shown in FIG. 7 is the same as the first embodiment of the handheld flashlight 10 in FIG. 2, 3 and 4 except that a recess 300 in the spool housing 318 centered around the aperture 68 can hold the flashlight housing 20 when the flashlight 12 is retracted back to the spool housing 318 as shown in FIG. 7. The recess 300 is in the outside of the first major wall 346 of the housing 318.

The recess 300 is the same shape as the base 34 of the flashlight housing 20 and slightly larger in size in all three dimensions. The flashlight housing will fit securely within the recess but the flashlight housing can still be easily pulled away from the housing for use of the flashlight. The recess 300 provides full contact between the magnetic reed switch 26 in the flashlight housing 20 and the magnet 78 in the spool housing 318.

The fifth embodiment of the handheld flashlight 410 as shown in FIG. 8 is the same as the first embodiment of the handheld flashlight 10 in FIG. 2, 3 and 4 except that the aperture 468 in the spool housing 418 is in the first side wall 450 of the spool housing 418, the magnet 478 is positioned near the aperture 468 on the first side wall 450 of the spool housing 418, and the spool housing 418 does not have a ring. The aperture 468 is shown in the Figure as centered in the first side wall 450. As an alternative, the aperture can be positioned off-center anywhere in the first side wall 450.

The aperture 468 is in line with the traverse 64 of the spool 40.

The tether 16 will run from the flashlight housing outside the spool housing through the aperture 468 in the spool housing into the interior cavity 44 of the spool housing. The tether will run directly from the aperture 468 to wind around the barrel 60 between the first and second flanges 58 and 62 in the traverse 64.

When the flashlight housing is extended away from the spool housing by the user, the tether will unwind from the barrel between the first and second flanges in the traverse of the spool. The tether will play out through the aperture to the flashlight housing.

When the flashlight housing is retracted back to the spool housing, the tether will pull in through the aperture and then wind up around the barrel between the first and second flanges in the traverse of the spool.

In the retracted position, the flashlight is retained against the outside of the first side wall of the spool housing.

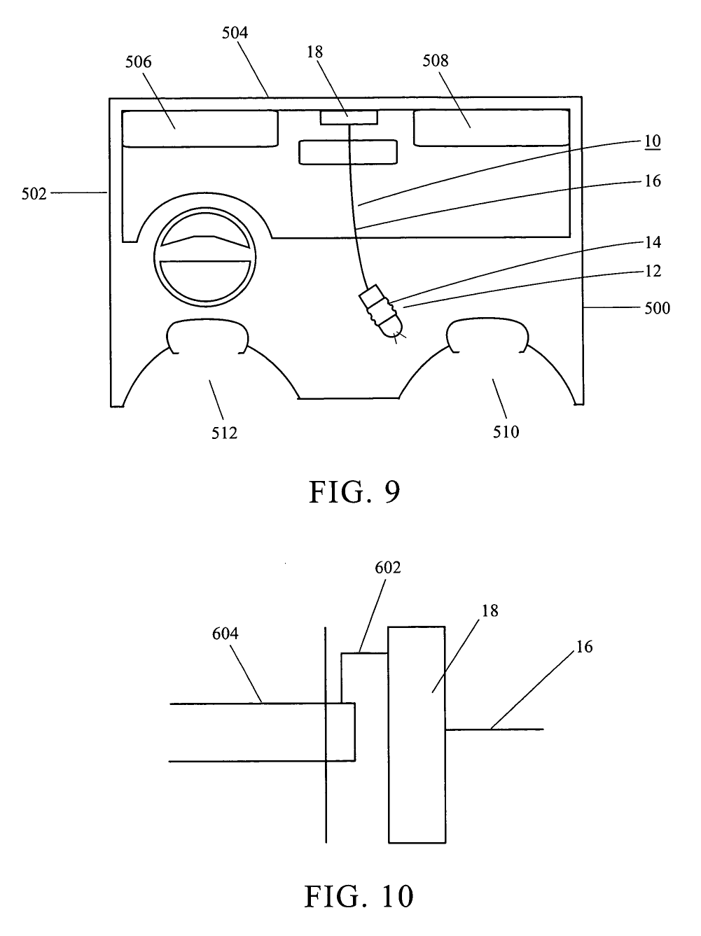

The spool housing can itself be part of a structure. As shown in FIG. 9, the hand-held retractable flashlight system 10 of the present invention is mounted inside an automobile 500.

The hand-held retractable flashlight system 10 is the map light in the interior passenger compartment 502 of the automobile. The spool housing 18 is mounted on the front section 504 of the roof, between the driver's visor 506 and the passenger's visor 508.

In the retracted position, the flashlight 12 is retained against the spool housing 18. As discussed previously, the flashlight is not emitting light into the interior of the automobile. The driver or the passenger grasps the gripping means 14 and pulls the flashlight 12 away from the spool housing 18. The light source in the flashlight emits light. The driver or passenger's hand holding the flashlight will direct the light to any place the user desires.

As the flashlight 12 is pulled away from the housing 18, the attached tether 16 unwinds from the spool housing 18. As the flashlight is released from the user's hand, or as the user's hand retains the flashlight but slackens the pull on the tether, the spring in the spool housing retracts the tether and attached flashlight back to the spool housing. Once the flashlight is retained against the spool housing, the light source stops emitting light.

Typically, a prior art map light is fixed in position on the front of the roof. The light shines down to a fixed position with fixed level of brightness on either the passenger seat 510, the driver's seat 512 or some middle point between the driver and passenger. The map or other item has to be moved by the driver or passenger into the light to be viewed and/or moved closer to the light in the roof to increase the brightness of the light.

With the hand-held retractable flashlight system 10 of the present invention as the retractable map light, the flashlight 12 is moved to illuminate the map or item and/or moved closer to increase the brightness of the illumination on the map or item.

The retractable flashlight can be extended to illuminate the footwell, under the driver or passenger seat, or even behind the driver or passenger seat, all impossible positions for the conventional fixed map light. The flashlight can even be used to illuminate outside the automobile, including to the side of the automobile, a position which none of the automobile's conventional lights (map light, dome light, glove compartment light, door light, head light, or back light) can currently illuminate.

The hand-held flashlight as map light of the present invention can be used by either the driver or passenger.

The retractable nature of the hand-held flashlight as map light prevents the flashlight from becoming lost in the automobile or outside the automobile. Even under dark or extreme conditions, the driver or passenger always knows the flashlight is retracted and positioned in the spool housing in the map light.

The hand-held retractable flashlight system 10 as the map light in the interior passenger compartment 502 of the automobile can be any of the previously disclosed embodiments of the present invention.

The spool housing can be manufactured integral with the automobile roof.

The spool housing and the hand-held retractable flashlight system can also be mounted or manufactured integral with the interior or exterior of a building or on a portable device.

The spool housing 18 can have a clip 602 on an outside surface so the hand-held retractable flashlight system 10 of the present invention can be securely carried on the belt 604 of the user as seen in FIG. 10. Attaching the spool housing to the belt allows easy access by the user to grasp and hold the flashlight by hand. The clip allows the hand-held retractable flashlight system 10 to be removably attached. The clip would typically be metal or plastic.

The spool housing may also be clipped to a pants pocket or a shirt pocket of the user.

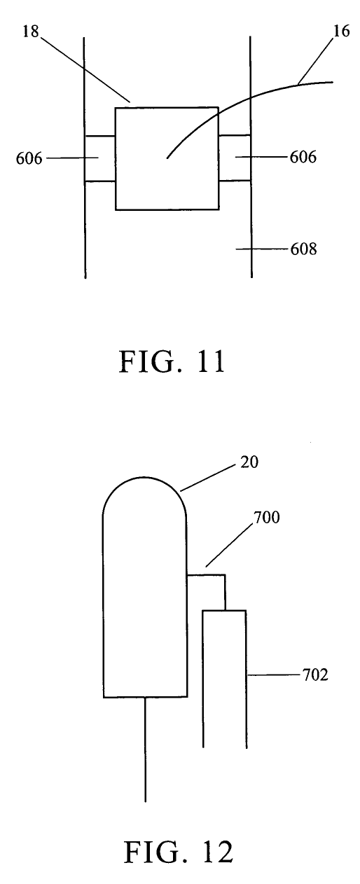

As show in FIG. 11, the spool housing 18 can have a strap 606 on an outside surface so the hand-held retractable flashlight system 10 of the present invention can be securely carried on the wrist 608 of the user. The spool housing may also be strapped to a forearm of the user.

The attachment means on the exterior of the flashlight housing may include a two piece buckle strap made of leather, plastic, fabric or another flexible material; a two piece Velcro strap made of similar materials as the two piece buckle strap, a one piece expandable strap made of plastic, fabric or another flexible material; or a sticky adhesive coating on the outside of the spool housing.

The attachment means may be a magnet if the magnet does not effect the magnetic reed switch in the base of the flashlight housing.

The attachment means should hold the hand-held retractable flashlight system 10 to the belt in any weather condition or environment.

The attachment means of a clip 602 or strap 606 for the hand-held retractable flashlight system 10 of the present invention allows the flashlight system to be secured to any article of clothing the user may be wearing or any part of the user's body.

The exterior of the flashlight housing 20 may have a clip 700 to secure the flashlight to an object 702 as shown in FIG. 12. The use of a securing means allows a hands-free operation of the hand-held retractable flashlight system 10 of the present invention. The user can move into the light emitted by the flashlight or move to one side or move away to undertake the user's tasks. The tether from the flashlight housing to the spool housing still connects the user to the flashlight. The clip would typically be metal or plastic.

The securing means on the exterior of the flashlight housing may include a two piece buckle strap made of leather, plastic, fabric or another flexible material; a two piece Velcro strap made of similar materials as the two piece buckle strap, a one piece expandable strap made of plastic, fabric or another flexible material; or a sticky adhesive coating on the outside of the spool housing. The securing means may be a magnet if the magnet does not effect the magnetic reed switch in the base of the flashlight housing. The securing means should hold the flashlight to the object in any weather condition or environment.

The length of the tether will depend upon the intended use of the hand-held retractable flashlight system 10 of the present invention. If the flashlight is just intended to be hand-held and if the spool housing is attached to the body or clothes of the user, the tether will be of sufficient length to extend across the body or clothes to a full arm's extension of the user. Alternately, if the flashlight is to be attached to an object or if the spool housing is to be attached to an object or both, the tether will be considerably longer in length.

An alternate embodiment of the hand-held retractable flashlight system 10 of the present invention would have a digital clock on the flashlight housing or the spool housing.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A hand-held retractable flashlight comprising
a housing having a rotatable spool within said housing, a biasing means within said housing to bias the rotation of said rotatable spool;
a flashlight having a light source for emitting light from a first end of said flashlight, a power source for supplying current to said light source, and a contact switch at a second end of said flashlight for completing the electrical circuit between said light source and said power source, said second end of said flashlight opposite said first end of said flashlight;
a tether connecting said second end of said flashlight to said rotatable spool within said housing such that said flashlight on said tether can extend away from said housing and retract back to said housing, said biasing means biasing said rotatable spool and said tether to retract said flashlight to said housing;
gripping means on said flashlight for securably holding said flashlight by a user to extend said flashlight on said tether from said housing and retract said flashlight on said tether back to said housing; and
wherein said contact switch turns on said flashlight to emit light when said flashlight on said tether extends and retracts from said housing and said contact switch turns off said flashlight to not emit light when said flashlight is physically adjacent to said housing.

2. The hand-held retractable flashlight of claim 1 wherein said biasing means is a coil spring.

3. The hand-held retractable flashlight of claim 1 wherein said contact switch is a magnetic reed switch.

4. The hand-held retractable flashlight of claim 2 further comprising a magnet in said housing for closing said magnetic reed switch.

5. The hand-held retractable flashlight of claim 1 wherein said contact switch is a pushbutton switch.

6. The hand-held retractable flashlight of claim 1 wherein said gripping means is at least one ridge on said flashlight.

7. The hand-held retractable flashlight of claim 1 wherein said light source is at least one light emitting diode.

8. The hand-held retractable flashlight of claim 1 wherein said light source is at least one battery.

9. The hand-held retractable flashlight of claim 1 further comprising attachment means for attaching said housing to the clothes or body of said user.

10. The hand-held retractable flashlight of claim 9 wherein said attachment means is a clip.

11. The hand-held retractable flashlight of claim 9 wherein said attachment means is a strap.

12. The hand-held retractable flashlight of claim 1 further comprising attachment means for attaching said flashlight to an object.

13. The hand-held retractable flashlight of claim 1 further comprising a recess in said housing for holding said second end of said flashlight when said flashlight is retracted back to said housing.

14. The hand-held retractable flashlight of claim 1 further comprising a ring in said housing for redirecting said tether from said rotatable spool to an aperture.

15. The hand-held retractable flashlight of claim 1 further comprising a bracket within said housing for holding said rotatable spool within said housing.

16. The hand-held retractable flashlight of claim 1 wherein said biasing means is at least one strand of flexible material.

17. The hand-held retractable flashlight of claim 1 wherein said housing is mounted in the interior of an automobile.

18. The hand-held retractable flashlight of claim 1 wherein said first end of said flashlight is a lens for focusing said light emitted by said light source.

19. A hand-held retractable flashlight comprising
a housing having a rotatable spool within said housing, a coil spring within said housing to bias the rotation of said rotatable spool;
a flashlight having a light emitting diode source for emitting light from a first end of said flashlight, a power source for supplying current to said light emitting diode source, and a magnetic reed switch at a second end of said flashlight for completing the electrical circuit between said light emitting diode source and said power source, said second end of said flashlight opposite said first end of said flashlight;
a tether connecting said second end of said flashlight to said rotatable spool within said housing such that said flashlight on said tether can extend away from said housing and retract back to said housing, said coil spring biasing said rotatable spool and said tether to retract said flashlight to said housing;
at least one ridge on said flashlight for securably holding said flashlight by a user to extend said flashlight on said tether from said housing and retract said flashlight on said tether back to said housing; and
wherein said magnetic reed switch turns on said flashlight to emit light when said flashlight on said tether extends and retracts from said housing and said magnetic reed switch turns off said flashlight to not emit light when said flashlight is physically adjacent to said housing.

20. The hand-held retractable flashlight of claim 19 further comprising attachment means for attaching said housing to the clothes or body of said user.

21. The hand-held retractable flashlight of claim 20 wherein said attachment means is a clip.

22. The hand-held retractable flashlight of claim 20 wherein said attachment means is a strap.

23. The hand-held retractable flashlight of claim 19 further comprising attachment means for attaching said flashlight to an object.

24. The hand-held retractable flashlight of claim 19 further comprising a recess in said housing for holding said second end of said flashlight when said flashlight is retracted back to said housing.

25. The hand-held retractable flashlight of claim 19 further comprising a ring in said housing for redirecting said tether from said rotatable spool to an aperture.

26. The hand-held retractable flashlight of claim 19 further comprising a bracket within said housing for holding said rotatable spool within said housing.

27. The hand-held retractable flashlight of claim 19 wherein said housing is mounted in the interior of an automobile.

28. A hand-held retractable flashlight comprising
a housing having a rotatable spool within said housing, a power source on said rotatable spool, a biasing means within said housing to bias the rotation of said rotatable spool;
a flashlight having a light source for emitting light from a first end of said flashlight, said power source in said housing for supplying current to said light source, and a contact switch at a second end of said flashlight, said second end of said flashlight opposite said first end of said flashlight;
a tether connecting said second end of said flashlight to said rotatable spool within said housing such that said flashlight on said tether can extend away from said housing and retract back to said housing, said biasing means biasing said rotatable spool and said tether to retract said flashlight to said housing, said tether being electrically conductive for supplying current from said power source in said housing to said contact switch and said light source in said flashlight with said contact switch completing the electrical circuit between said light source and said power source;
gripping means on said flashlight for securably holding said flashlight by a user to extend said flashlight on said tether from said housing and retract said flashlight on said tether back to said housing; and
wherein said contact switch turns on said flashlight to emit light when said flashlight on said tether extends and retracts from said housing and said contact switch turns off said flashlight to not emit light when said flashlight is physically adjacent to said housing.
